(19) United States
(12) Patent Application Publication
(10) Pub. No.: US 2020/0307096 A1
(43) Pub. Date: Oct. 1, 2020

(54) REPAIR SYSTEM AND METHOD OF REPAIRING A SUBSTRATE

(71) Applicant: GM Global Technology Operations LLC, Detroit, MI (US)

(72) Inventors: Matthew P. Simonin, Ortonville, MI (US); Robert N. Saje, Shelby Township, MI (US); Paul J. Wolcott, Macomb, MI (US)

(73) Assignee: GM Global Technology Operations LLC, Detroit, MI (US)

(21) Appl. No.: 16/363,515

(22) Filed: Mar. 25, 2019

(51) Int. Cl. B29C 64/386; B29C 64/165; B29C 73/00; B33Y 10/00; B33Y 30/00; B33Y 50/00

(52) U.S. Cl. CPC B29C 64/386; B29C 64/165; B33Y 50/00; B33Y 10/00; B33Y 30/00; B29C 73/00

(57) ABSTRACT

A repair system includes a scanning system configured for determining a contour of a void surface. The repair system also includes an additive manufacturing system configured for sequentially printing a plurality of individual layers each disposed on one another adjacent the void surface according to the contour. A method of repairing a substrate having a damaged portion defining a void and having the void surface is also disclosed.

### INTRODUCTION

The disclosure relates to a repair system and method of repairing a substrate having a damaged portion that defines a void.

Devices such as vehicles may be operated in harsh conditions and environments and may occasionally be damaged during use. For example, vehicle bodies may be dented or punctured upon contact with an object. Likewise, vehicle interior surfaces may be scratched, nicked, perforated, or otherwise damaged during operation of the vehicle.

### SUMMARY

A repair system includes a substrate having a damaged portion defining a void and having a void surface, and a scanning system configured for determining a contour of the void surface. The repair system also includes a patch having the contour and including a plurality of individual layers each disposed on one another. Further, the repair system includes an additive manufacturing system configured for sequentially printing the plurality of individual layers. The repair system also includes an attachment material disposed in contact with the patch and the substrate such that the patch fills the void.

In one aspect, the attachment material is an adhesive.

In another aspect, the attachment material is a filler composition configured to blend together the patch and the substrate.

In one embodiment, a repair system includes a scanning system configured for determining a contour of a void surface. The repair system also includes an additive manufacturing system configured for sequentially printing a plurality of individual layers each disposed on one another adjacent the void surface according to the contour.

In one aspect, the repair system may further include a substrate having a damaged portion defining a void and having the void surface.

In one aspect, the additive manufacturing system may be mounted to the substrate adjacent to the void.

In another aspect, the additive manufacturing system may be characterized as a standalone apparatus and may not be attached to the substrate.

In a further aspect, the substrate may have a depth and the void may be a crack that does not extend through an entirety of the depth. Alternatively, the void may be a hole that does extend through an entirety of the depth.

In an additional aspect, the plurality of individual layers may together form a patch attached to the substrate within the void. The patch may be adhered to the substrate. Alternatively or additionally, each of the plurality of individual layers may be blended with the substrate along the contour. Further, the substrate and the patch may be formed from the same material.

In one aspect, the substrate may be an exterior panel of a vehicle.

A method of repairing a substrate having a damaged portion defining a void and having a void surface includes scanning the substrate with a scanning system to thereby determine a contour of the void surface. The method also includes additively manufacturing a patch having the contour and including a plurality of individual layers printed individually and each disposed on one another. Further, the method includes attaching the patch to the substrate within the void to thereby fill the void.

In one aspect, the method may further include, prior to scanning, mounting the scanning system to the substrate adjacent the void.

In another aspect, additively manufacturing may include printing the plurality of individual layers directly into the void to thereby form the patch in situ.

In a further aspect, additively manufacturing may include forming the patch external to the void before attaching the patch.

In yet another aspect, the method may further include, before attaching, disposing an attachment material on at least one of the patch and the substrate within the void.

In an additional aspect, the method may further include producing a set of instructions readable by an additive manufacturing system configured for additively manufacturing the patch.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a repair system and method for repairing a substrate having a damaged portion defining a void.

FIG. 2 is a schematic illustration of another embodiment of the repair system and method of FIG. 1.

FIG. 3 is a schematic illustration of one embodiment of the void defined by the substrate of FIGS. 1 and 2.

FIG. 4A is a schematic illustration of a cross-sectional view of a patch disposed within the void defined by the substrate of FIG. 1 and formed by the methods of FIGS. 1 and 2.

FIG. 4B is a schematic illustration of a cross-sectional view of another embodiment of the patch of FIG. 4A.

FIG. 5 is a schematic illustration of a perspective view of the patch of FIGS. 4A and 4B disposed within the void defined by the substrate of FIG. 1 and formed by the methods of FIGS. 1 and 2.

### DETAILED DESCRIPTION

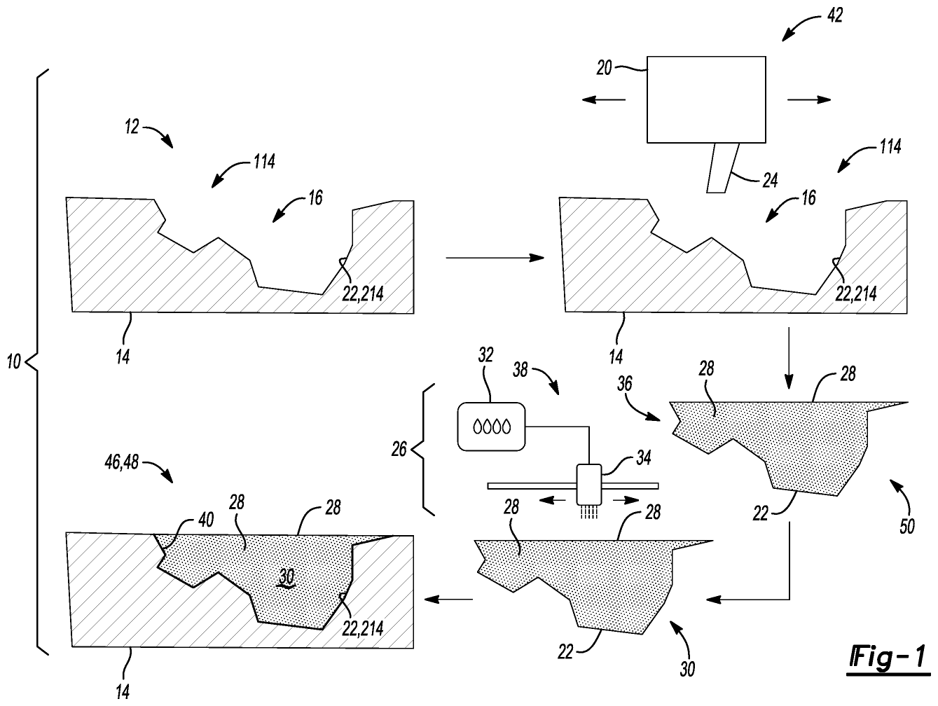

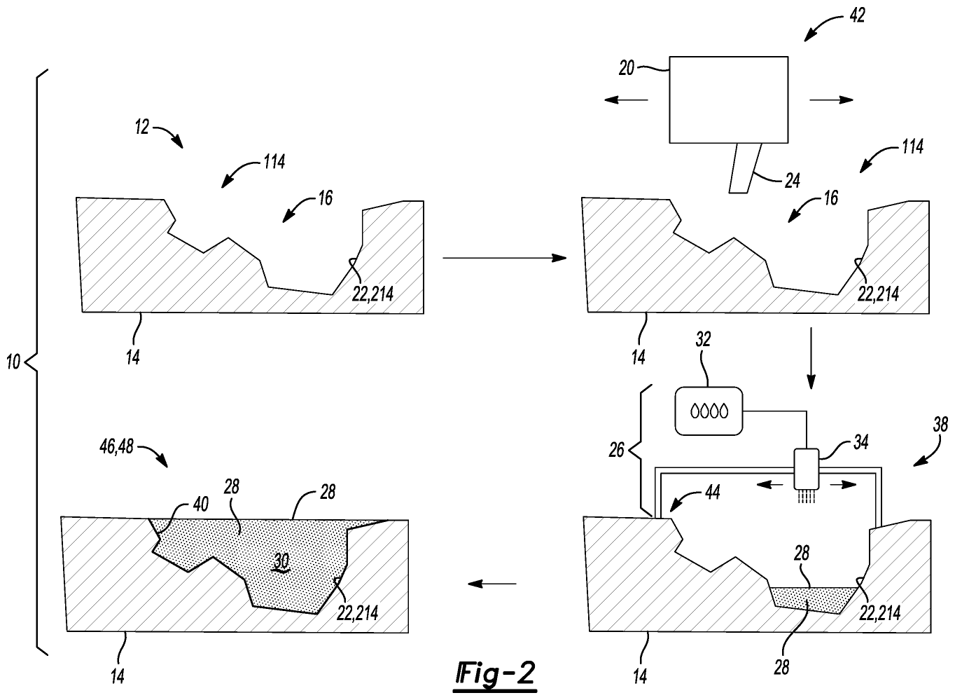

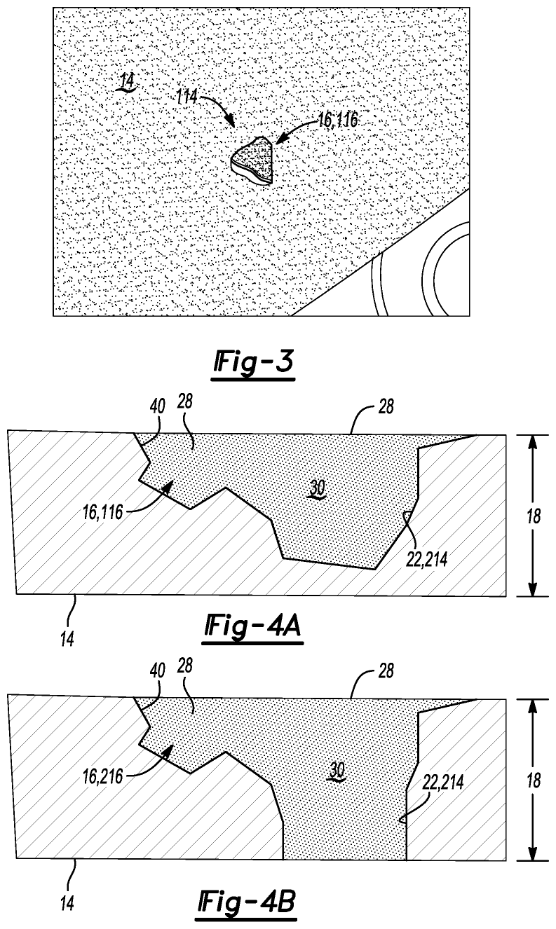

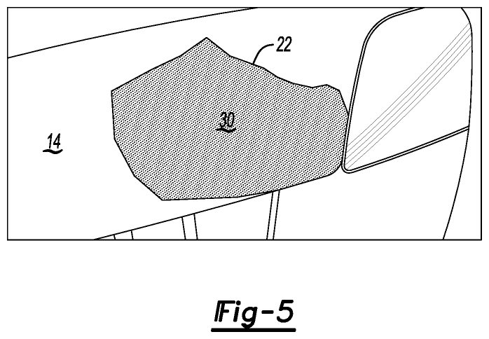

Referring to the Figures, wherein like reference numerals refer to like elements, a repair system 10 and method 12 of repairing a substrate 14 having a damaged portion 114 defining a void 16 and having a void surface 214 are shown generally in FIGS. 1 and 2. The repair system 10 and method 12 may be useful for repairing damaged substrates 14 that are cracked, scratched, dented, nicked, torn, and/or define a hole 216 (FIG. 4B) completely through the substrate 14. In particular, the repair system 10 and method 12 may be useful for repairing the substrate 14 in situ, i.e., without removing the substrate 14 from a device before repairing the substrate 14. As shown in FIG. 3, in one non-limiting example, the substrate 14 may be an interior surface of a vehicle that is scratched or perforated. In another non-limiting example shown in FIG. 5, the substrate 14 may be an exterior panel of a vehicle, such as a quarter panel, door panel, decklid, hood, roof, fender, and the like, that is dented or punctured. As such, the repair system 10 and method 12 may be useful for repairing automotive vehicles such as a passenger car, sport utility vehicle, or truck. Alternatively, the repair system 10 and method 12 may be useful for repairing another vehicle type, such as, but not limited to, an industrial vehicle, a recreational off-road vehicle, a motorcycle, an airplane and the like. However, the repair system 10 and method 12 may also be useful for repairing substrates 14 for non-automotive applications, such as cabinetry, furniture, and building exteriors.

Referring again to FIGS. 1 and 2, in one embodiment, the repair system 10 includes the substrate 14 having the damaged portion 114. The damaged portion 114 defines the void 16 and has the void surface 214 and may be distinguished from a non-damaged portion (not shown) of the substrate 14 that is not damaged or deformed. That is, the void 16 may be a type of damage or deformation to the substrate 14. For example, as shown in FIG. 4A, the substrate 14 may have a depth 18, and the void 16 may be a crack 116 or separation that does not extend through an entirety of the depth 18. Alternatively, as shown in FIG. 4B, the void 16 may be a hole 216 that extends through an entirety of the depth 18 of the substrate 14. The substrate 14 may be formed from a material such as, but not limited to, metal, fiberglass, composite, cured film, plastic, wood, rubber, and the like.

As shown in FIGS. 1 and 2, the repair system 10 also includes a scanning system 20 configured for determining a contour 22 of the void surface 214. That is, the contour 22 of the void surface 214 may follow a deformed surface of the substrate 14 and define a shape of the void surface 214. The scanning system 20 may include, for example, a laser 24 configured to traverse the void 16 and thereby map the contour 22. Alternatively, the scanning system 20 may include a sensor or optical eye (not shown) configured for determining the contour 22 of the void surface 214. The scanning system 20 may also include memory configured for storing data associated with the contour 22 and one or more processors configured for manipulating the data.

As described with continued reference to FIGS. 1 and 2, the repair system 10 also includes an additive manufacturing system 26 configured for sequentially printing a plurality of individual layers 28 each disposed on one another adjacent the void surface 214 according to the contour 22. Stated differently, the additive manufacturing system 26 may be configured for sequentially printing the plurality of individual layers 28 each disposed on one another within the void 16 according to the contour 22 to thereby fill the void 16. The additive manufacturing system 26 may be characterized as one or more of a material jetting additive manufacturing system 26, a powder bed fusion additive manufacturing system 26, a vat photopolymerization additive manufacturing system 26, a binder jetting additive manufacturing system 26, a material extrusion additive manufacturing system 26, a directed energy deposition additive manufacturing system 26, and a sheet lamination additive manufacturing system 26.

In one non-limiting example, the additive manufacturing system 26 may be characterized as a three-dimensional (3D) printing system that may include components arranged to sequentially dispose the plurality of individual layers 28 against one another to join or solidify the plurality of individual layers 28 together under computer control and create a three-dimensional patch 30 (FIG. 1) having the same shape or contour 22 as the void surface 214. For example, the additive manufacturing system 26 may form the plurality of individual layers 28 from a material such as liquid molecules or powder grains and deposit the plurality of individual layers 28 one at a time onto one another to thereby form the patch 30. As such, the additive manufacturing system 26 may include a material supply component 32 having one or more material print heads 34 configured for expelling the material into the void 16.

In one embodiment illustrated in FIG. 2, the additive manufacturing system 26 may be mounted to the substrate 14 adjacent to the void 16. That is, the additive manufacturing system 26 may attach directly to the substrate 14, e.g., via suction or adhesive, and surround the void 16. As such, the additive manufacturing system 26 and/or repair system 10 may be portable. That is, the repair system 10 may be transported on a cart or in an assistance vehicle to provide for immediate, in situ repairs of the void 16. During operation, the additive manufacturing system 26 may electronically communicate with the scanning system 20, and the print heads 34 may traverse the void 16 to thereby sequentially deposit the plurality of individual layers 28 onto one another to form the patch 30 within the void 16.

In another embodiment illustrated in FIG. 1, the additive manufacturing system 26 may be characterized as a standalone apparatus and may not be attached to the substrate 14. For this embodiment, the scanning system 20 may produce or create a set of instructions 36 readable by the additive manufacturing system 26 that is configured for additively manufacturing 38 the patch 30. For example, the set of instructions 36 may be a computer-aided design data file that may include data regarding a size, contour 22, depth, width, volume, and/or height of the damaged portion 114 and void surface 214. Further, the set of instructions 36 may include data regarding the material, color, sheen, etc. of the substrate 14 and/or the plurality of individual layers 28 required to form the patch 30. The set of instructions 36 may be transmitted to and/or read by the additive manufacturing system 26.

Therefore, referring now to FIGS. 4A and 4B, in one embodiment, the repair system 10 includes the patch 30 having the contour 22 and including the plurality of individual layers 28 disposed on one another. That is, the plurality of individual layers 28 may together form the patch 30 attached to the substrate 14 within the void 16.

The patch 30 may be attached to the substrate 14 by one or more suitable means. For example, the patch 30 may be adhered to the substrate 14, such as in instances where the patch 30 is formed external to the void 16 and then subsequently disposed within the void 16. As such, the repair system 10 also includes an attachment material 40 disposed in contact with the patch 30 and the substrate 14 such that the patch 30 fills the void 16. For this embodiment, the attachment material 40 may be an adhesive. In addition, although not shown, the patch 30 may have a slightly smaller volume than a volume of the void 16 such that the patch 30 and the void surface 214 define a gap (not shown) therebetween when the patch 30 is inserted into the void 16. Therefore, the attachment material 40 may be inserted into the gap and may expand to fill the gap upon, for example, curing of the attachment material 40 to thereby adhere the patch 30 to the substrate 14. That is, the gap may provide a region in which the attachment material 40 may expand upon compression by the patch 30 without overflowing onto an exterior surface of the substrate 14. Alternatively or additionally, the patch 30 may be formed to include one or more localized standoffs (not shown) also configured to space the patch 30 apart from the void surface 214, define the gap, and allow for insertion of the attachment material 40 into the gap without over-compression of the attachment material 40.

Alternatively, each of the plurality of individual layers 28 may be blended with the substrate 14 along the contour 22. That is, the substrate 14 and the patch 30 may be formed from the same material and the additive manufacturing system 26 may melt or soften the substrate 14 along the contour 22 of the void surface 214 as the additive manufacturing system 26 sequentially deposits each of the plurality of individual layers 28 onto one another within the void 16. Therefore, the patch 30 may combine with the substrate 14 along the contour 22.

However, in some embodiments, the patch 30 and the substrate 14 may be formed from different materials. Therefore, in some instances, the attachment material 40 may be a filler composition configured to blend together the patch 30 and the substrate 14. Further, the patch 30 may be painted or colorized subsequent to attaching 46 (FIG. 2) to the substrate 14 to match an appearance and/or texture of the substrate 14.

In one embodiment, the patch 30 may be solid. That is, the plurality of individual layers 28 may stack upon one another to form a solid body, i.e., the patch 30. However, in another embodiment, the plurality of individual layers 28 may be disposed upon one another to form a hollow body, i.e., the patch 30, having a solid exterior surface that seamlessly abuts with an external surface of the substrate 14. That is, the patch 30 may be solid or hollow. In either instance, as a non-limiting example, the patch 30 may be coated with a cured film formed from a coating composition, e.g., a paint or clearcoat, such that an appearance of the patch 30 is indistinguishable from an appearance of the substrate 14. However, the patch 30 may also be additively manufactured, e.g., printed, to already match an appearance, color, and sheen of the substrate 14 and may not require a coating or cured film.

Referring again to FIGS. 1 and 2, the method 12 of repairing the substrate 14 includes scanning 42 the substrate 14 with the scanning system 20 to thereby determine the contour 22 of the void surface 214. As set forth above, the method 12 may also include, prior to scanning 42, mounting 44 the scanning system 20 to the substrate 14 adjacent to the void 16. Scanning 42 may include ascertaining or determining the contour 22 by reading the contour 22 with a laser. Alternatively, scanning 42 may include reflecting a sound wave or light off the contour 22 to determine the contour 22.

Further, the method 12 includes additively manufacturing 38 the patch 30 having the contour 22 and including the plurality of individual layers 28 printed individually and disposed on one another. The method 12 also includes attaching 46 the patch 30 to the substrate 14 within the void 16 to thereby fill the void 16. Attaching 46 may include adhering the patch 30 to the substrate 14 with the attachment material 40, or may include blending together the patch 30 and the substrate 14 along the contour 22.

In one embodiment, additively manufacturing 38 may include printing the plurality of individual layers 28 directly into the void 16 to thereby form the patch 30 in situ. That is, additively manufacturing 38 may include ejecting the material, such as liquid molecules or powder grains, from the print heads 34 to thereby deposit the material and form the plurality of individual layers 28 within the void 16. Alternatively, in another embodiment, additively manufacturing 38 may include forming the patch 30 external to the void 16 before attaching 46 the patch 30.

As set forth above, the method 12 may further include, before attaching 46, disposing 48 the attachment material 40 on at least one of the patch 30 and the substrate 14 within the void 16. That is, disposing 48 may include coating the void surface 214 and/or patch 30 with the attachment material 40 such that the patch 30 adheres to or blends with the substrate 14. Further, disposing 48 may include offsetting the patch 30 from the void surface 214 by one or more standoffs to define a gap between the patch 30 and the void surface 214. Disposing 48 may also include inserting the attachment material 40 into the gap to thereby allow for compression of the attachment material 40 by the patch 30 within the void 16 without overflow of the attachment material 40 onto an external surface of the substrate 14. The method 12 may also include producing 50 the set of instructions 36 readable by the additive manufacturing system 26 that is configured for additively manufacturing 38 the patch 30. That is, producing 50 may include creating data readable by a processor of the additive manufacturing system 26.

Therefore, the repair system 10 and method 12 may seamlessly repair the damaged substrate 14. That is, the patch 30 formed by the repair system 10 and method 12, whether formed in situ or external to the substrate 14, may blend seamlessly with the substrate 14 such that the patch 30 ameliorates the void 16 and damaged portion 114 and the patch 30 is not visible as a repair. Further, the repair system 10 may be portable and economical to use, and therefore may reduce repair costs and repair time for the damaged substrate 14. In addition, the repair system 10 and method 12 may provide easily reproducible patches 30 suitable for any type, size, shape or contour 22, depth 18, texture, and/or appearance of the damaged portion 114 and void surface 214. As such, the repair system 10 and method 12 may reduce or eliminate removal and/or replacement of the entire substrate 14 when the substrate 14 is damaged.

While the best modes for carrying out the disclosure have been described in detail, those familiar with the art to which this disclosure relates will recognize various alternative designs and embodiments for practicing the disclosure within the scope of the appended claims.

What is claimed is:

1. A repair system comprising:
a substrate having a damaged portion defining a void and having a void surface;
a scanning system configured for determining a contour of the void surface;
a patch having the contour and including a plurality of individual layers each disposed on one another;
an additive manufacturing system configured for sequentially printing the plurality of individual layers; and
an attachment material disposed in contact with the patch and the substrate such that the patch fills the void.

2. The repair system of claim 1, wherein the attachment material is an adhesive.

3. The repair system of claim 1, wherein the attachment material is a filler composition configured to blend together the patch and the substrate.

4. A repair system comprising:
a scanning system configured for determining a contour of a void surface; and
an additive manufacturing system configured for sequentially printing a plurality of individual layers each disposed on one another adjacent the void surface according to the contour.

5. The repair system of claim 4, further including a substrate having a damaged portion defining a void and having the void surface.

6. The repair system of claim 5, wherein the additive manufacturing system is mounted to the substrate adjacent to the void.

7. The repair system of claim 5, wherein the additive manufacturing system is characterized as a standalone apparatus and is not attached to the substrate.

8. The repair system of claim 5, wherein the substrate has a depth and the void is a crack that does not extend through an entirety of the depth.

9. The repair system of claim 5, wherein the substrate has a depth and the void is a hole that extends through an entirety of the depth.

10. The repair system of claim 5, wherein the plurality of individual layers together form a patch attached to the substrate within the void.

11. The repair system of claim 10, wherein the patch is adhered to the substrate.

12. The repair system of claim 10, wherein each of the plurality of individual layers is blended with the substrate along the contour.

13. The repair system of claim 10, wherein the substrate and the patch are formed from the same material.

14. The repair system of claim 5, wherein the substrate is an exterior panel of a vehicle.

15. A method of repairing a substrate having a damaged portion defining a void and having a void surface, the method comprising:
scanning the substrate with a scanning system to thereby determine a contour of the void surface;
additively manufacturing a patch having the contour and including a plurality of individual layers printed individually and each disposed on one another; and
attaching the patch to the substrate within the void to thereby fill the void.

16. The method of claim 15, further including, prior to scanning, mounting the scanning system to the substrate adjacent the void.

17. The method of claim 15, wherein additively manufacturing includes printing the plurality of individual layers directly into the void to thereby form the patch in situ.

18. The method of claim 15, wherein additively manufacturing includes forming the patch external to the void before attaching the patch.

19. The method of claim 15, further including, before attaching, disposing an attachment material on at least one of the patch and the substrate within the void.

20. The method of claim 15, further including producing a set of instructions readable by an additive manufacturing system configured for additively manufacturing the patch.
